(19) United States
(12) Patent Application Publication
(10) Pub. No.: US 2024/0232936 A1
(43) Pub. Date: Jul. 11, 2024

(54) MODEL ORCHESTRATOR

(71) Applicant: Google LLC, Mountain View, CA (US)

(72) Inventors: Francesco Nerieri, San Francisco, CA (US); Di-Fa Chang, Cupertino, CA (US); Lan Huang, Menlo Park, CA (US); Xinlong Bao, Los Altos, CA (US)

(21) Appl. No.: 18/009,293

(22) PCT Filed: Aug. 9, 2022
(86) PCT No.: PCT/US2022/039866

§ 371 Date: Dec. 8, 2022

(51) Int. Cl. G06Q 30/0242

(52) U.S. Cl. CPC G06Q 30/0244

(57) ABSTRACT

Methods, systems, and apparatus, including computer programs encoded on a computer storage medium, for determining attributions for unattributed outcomes across different content channels. The method includes receiving, by a model orchestrator, outcome data representing a set of unattributed outcomes, where each unattributed outcome does not have an observed attribution to an exposure of a set of predetermined exposures. The attribution data representing a set of modeled attributions from each outcome model of a plurality of outcome models are received by the model orchestrator, where each set of modeled attribution includes a respective measure between one or more unattributed outcomes and one or more exposures. The respective measures are updated based on one or more criteria for determining one or more updated attributions, where each updated attribution indicates a new attribution of a respective outcome from the set of unattributed outcomes to a corresponding exposure of the set of predetermined exposures.

### TECHNICAL FIELD

This specification generally relates to data processing and techniques for orchestrating models across different data channels.

### BACKGROUND

In a networked environment such as the Internet, content providers can provide information for display in electronic or digital form. The digital contents can be displayed in various electronic forms. For example, digital contents can be provided on a web page or in an execution environment (e.g., an iframe) defined in a webpage, integrated into a representation of query results, provided on application interfaces, or other suitable digital forms. The digital contents can be a video clip, audio clip, multimedia clip, image, text, or other suitable digital contents.

Users engage in various online activities, and each of these activities results in the users being exposed to different information. For example, the action of a user reading or viewing a digital content can be referred to as an exposure of the user to the particular digital content. Subsequent online activity such downloading and installing an application by a user can be influenced by their previous activity and the information to which they were exposed. A successful completion of an event by a user (e.g., completion of a subsequent user online activity) generally refers to an “outcome” or a “conversion.” Models can be used to determine, or predict, which online activities contributed to any given outcomes, and different models are generally implemented to operate independently on data obtained from different data channels.

### SUMMARY

As discussed throughout this specification, various techniques can be used to coordinate the work performed by models implemented on different data channels. For example, in a situation where different models operate on different data streams from different channels, a model orchestrator can be implemented to fill data gaps that may exist between the different data channels and/or the different models. In a specific example, assume that Model A is implemented to attribute observed outcomes to online activities specified in a data stream obtained from Data Channel 1, and that Model B is implemented to attribute observed outcomes to online activities specified in a different data stream obtained from Data Channel 2. In this example, privacy settings or other data restrictions may prevent Model A and/or Model B from obtaining information from one of the Data Channels, such that Model A and/or Model B may not have sufficient information to make an accurate attribution of one or more of the observed outcomes to the online activities. This can lead to unattributed observed outcomes and/or incorrectly attributed observed outcomes, which, in either case, results in a sub-optimal system that outputs erroneous or incomplete solutions.

For at least these reasons, existing techniques are generally inaccurate and even misleading for predicting attributions of outcomes without metadata indicating a clear path tracking back to exposures, in particular when the exposures occur through different content channels, as represented by data contained in different data streams. These types of outcomes are also referred to as “unattributed outcomes” in this document. To name just a few examples, a content channel can include at least one or more of a video streaming platform, a social messaging platform, an audio broadcasting platform, a search engine webpage, a retailing webpage, a virtual store for software applications, or other suitable content channels. In some implementations, a content channel can have one or more outcome models dedicated to determining attributions for the channel.

When a user is exposed to different digital content through different content channels that do not communicate user information with one another, one existing technique uses multiple outcome models to determine an attribution for an unattributed outcome. However, such a technique can generate conflicting results in the attributions, which again leads to a sub-optimal attribution system. For example, a first outcome model is configured to predict attributions to different exposures A, B, and C, and a second outcome model is configured to predict attributions to different exposures B. D. and F. For a common unattributed outcome, the first outcome model might determine that the common unattributed outcome is attributed to exposure A, and the second outcome model might determine that the common unattributed outcome is attributed to a different exposure, e.g., exposure F. The attributions generated from the first and second outcome models conflict. This could happen because each outcome model is designed and/or trained dedicatedly for a particular content channel (or dedicatedly for a particular set of predetermined exposures), and therefore might not have a “global view” of all exposures that an outcome can be attributed to.

The described techniques in the document can solve the above-noted difficulties faced by the existing techniques. A system implementing the described techniques is configured to determine attributions for the set of unattributed outcomes that were not able to be attributed with sufficient confidence by the outcome models implemented for each of the different content channels. More specifically, the system receives data representing a set of unattributed outcomes (referred to as “outcome data”) that do not have clear paths tracking back to corresponding exposures (or do not have observed attributions to corresponding exposures in a set of predetermined exposures). The system then receives data representing modeled attributions (referred to as “attribution data”). In some implementations, each modeled attribution indicates an attribution of an unattributed outcome to a type of exposure covered by the corresponding outcome model.

The modeled attributions are generated by multiple outcome models, where each outcome model generates a respective set of modeled attributions for at least a portion of the set of unattributed outcomes. Each set of the outcome models includes a respective measure between the respective portion of unattributed outcomes and corresponding exposures.

In some implementations, a respective measure can include a probability distribution indicating likelihoods for one or more unattributed outcomes to one or more corresponding exposures. Note the likelihood mappings between outcome and exposures can be arbitrary, e.g., the one to one mapping, the one to many mapping, or the many to one mapping. For example, the probability distribution can indicate a likelihood of an unattributed outcome being attributed to one or more corresponding exposures. As another example, a probability distribution can indicate a likelihood of one or more unattributed outcomes being attributed to a corresponding exposure.

The system updates the respective measures in the sets of modeled attributions received from the multiple outcome models using one or more criteria. To update the respective measures, the system is configured to determine one or more sets of modeled attributions that each at least have a measure for a common unattributed outcome. The system obtains a respective value from a measure determined by an outcome model. The value can be a likelihood of a common unattributed outcome being attributed to a respective exposure, or a real number representing a particular exposure that the common unattributed outcome is attributed to. The system determines whether to update a value based on one or more criteria. If one or more criteria are satisfied, the system updates the values to resolve any conflicts in the determined attributions across different outcome models for the common unattributed outcome.

The system determines one or more updated attributions based on the updated respective measures. Each of the updated attributions indicates a respective attributed outcome being attributed to a corresponding exposure of a set of predetermined exposures.

Optionally, the system determines whether one or more modeled attributions are different from the updated attributions, and responsive to determining that the one or more modeled attributions are different from the updated attributions, the system updates the one or more modeled attributions to align with the updated attributions. In some implementations where an outcome model does not cover a type of exposure for an outcome predicted by the updated attributions, the system can retract the modeled attribution for the unattributed outcome generated by the outcome model. The term “retract” generally refers to nullifying the modeled attribution for future references, and/or not storing the modeled attribution generated from the outcome model.

The one or more criteria used for updating respective measures can be determined by a user input or preset for the system, according to different attribution requirements. In some implementations, the one or more criteria can include an outcome volume threshold for an outcome model. For example, if an outcome model is assigned with a number of unattributed outcome that satisfies an outcome volume threshold, the system can determine to update values for the measure generated by the outcome model.

In some implementations, the one or more criteria can include an attribute associated with an unattributed outcome. For example, the attribute can be a geographical location associated with the unattributed outcome, and the geographical location can be optionally used to compare with a geographical location associated with an exposure predicted by a modeled attribution. As another example, the attribute can be a time value associated with the unattributed outcome, and the time value can be optionally used to compare with a time that a corresponding user was exposed to an exposure predicted by a modeled attribution. Furthermore, attributes associated with unattributed outcomes can include the type of devices and/or operating systems in which the outcomes occur. Example device type can include respective types for smartphones, computers, smart tablets, smart TVs, smart watches, or other device types. Example operating system type can include Windows, MacOS, Android, Linux, and other operating system types. In addition, attributes associated with unattributed outcomes can include information related to providers that provide digital content and types of the provided digital content. The digital content type can include a text, an image, a video, or other digital content types.

In some implementations, the one or more criteria can include a threshold similarity value between an unattributed outcome and an exposure predicted by a modeled attribution. For example, the system can generate a similarity value for the unattributed outcome and the exposure by determining a distance between features of the outcome and the exposure in an embedding space. The system can compare the similarity value with the threshold similarity value to determine whether the one or more criteria are satisfied.

In some implementations, the one or more criteria can include a threshold number of remaining unattributed outcomes in the set of unattributed outcomes. Alternatively or in addition, any one of the above-noted criteria can be dependent on the threshold number of remaining unattributed outcomes in the set of unattributed outcomes. For example, when the number of remaining unattributed outcomes satisfies the threshold number of remaining unattributed outcomes, the system does not update parameters of the modeled attribution. As another example, when the number of remaining unattributed outcomes satisfies the threshold number of remaining unattributed outcomes, at least one of the above-noted criteria are relaxed to different extents according to different requirements, e.g., the threshold similarity value might become a half of the original threshold value, or the geographical location criterion might be ignored.

Other embodiments of this aspect include corresponding methods, apparatus, and computer programs, configured to perform the above-noted actions of the methods, encoded on computer storage devices.

Particular embodiments of the subject matter described in this specification can be implemented so as to realize one or more of the following advantages. The described techniques improve the accuracy and efficiency for determining an attribution of an unattributed outcome to an exposure of a set of predetermined exposures. Particularly, for an outcome completed by a user exposed to one or more digital contents from one or more different channels, a system might not include metadata indicating a clear path for tracking back to an exposure for the outcome. This is due to, for example, due to, for example, privacy policies such that the user identification information might not be accessible when the one or more digital contents are displayed to a user from different channels. In these cases, the described techniques are efficient by determining attributions using modeled attributions generated from one or more outcome models, so that the described techniques do not spend time and computation resources to generate modeled attributions. Rather, the described techniques determine attributions by modifying or adjusting respective measure values in the modeled attributions based on one or more criteria. The one or more criteria are determined to resolve potential conflicts in attributions predicted by the multiple outcome models (e.g., one outcome being attributed to multiple different exposures by the multiple outcome models). The one or more criteria are further designed to take into consideration information from a global perspective, i.e., considering attributes associated with outcomes and global information from all of the outcome models, so that the attributions generated by the system are more accurate than those predicted by existing techniques. Furthermore, the techniques discussed herein address the problem of outcome attribution in situations where models created to perform the attribution are unable to adequately make an attribution based on the information available to the model. For example, when data needed to make an attribution of a given outcome with sufficient confidence, is not available to an individual model, a model orchestrator device can implement the techniques described herein by collecting the outputs from each of the different models, and attributing the given outcome based on the different model outputs and other data available to the model orchestrator (e.g., not available to the different models), thereby reducing the number of unattributed outcomes, while complying with any data sharing restrictions.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for determining attributions for unattributed outcomes.

FIG. 2 is a block diagram of an example model orchestrator included in the example system.

FIG. 3 is a flow diagram of an example process for determining attributions for unattributed outcomes.

FIG. 4 is a block diagram of an example computer system.

Like reference numbers and designations in the various drawings indicate like elements.

### DETAILED DESCRIPTION

Attributing outcomes to prior activities is a common application of models. However, the ability of a model to properly attribute the outcomes to the prior activities is limited, in part, by the data available when training and executing the model. In the context of online activities, there are privacy policies (and other restrictions) that prevent data from one content channel from being shared with another content channel, but user online activity that occurs prior to any given outcome can span across many different content channels. This lack of cross-channel data limits the ability for a given model to output attributions based on data from any given content channel. Therefore, a number of outcomes end up unattributed.

For example, users connected to the Internet are exposed to a variety of digital contents, e.g., search results, web pages, news articles, social media posts, audio information output by a digital assistant device, video streams, digital contents associated with one or more of the afore-mentioned digital contents, or other suitable digital contents. Some of these exposures to digital contents may contribute to the users performing or completing a specified target action as an outcome (also referred to as a conversion, as described above). For instance, a user that is exposed to a digital content, e.g., a user that views or to which the digital component is displayed, about a piece of furniture from a content channel may purchase the piece of furniture on a retailing platform. In this example, purchasing the piece of furniture generally refers to a user action performed or an event completed by the user in response to being exposed to the digital content from the content channel. In other words, the outcome of purchasing the piece of furniture can be considered attributed to the digital content displayed to the user. Similarly, a user that is exposed to another digital component regarding a video streaming service may ultimately download and install an application of the video streaming service, where downloading and installing the application is the outcome or the completion of an event, which can be considered attributed to the other digital content.

The term “exposure” throughout this document generally refers to an event where a user, viewer, or audience views or hears a digital content provided by a content provider. A digital content can include at least one or more of a video clip, audio clip, multimedia clip, image, text, or other suitable digital contents. A digital content can be provided in different forms, e.g., on a web page or a banner in a webpage, integrated into a representation of query results, provided on application interfaces, or in other suitable digital forms. In some implementations, the exposure event includes one or more user engagements with a provided digital content. A user engagement can include a positive or negative user interaction with a digital content, e.g., a positive interaction including a tap or a click on an intractable component in the digital content, or a negative interaction including a user scrolling past or closing a digital content presentation. In some implementations, a successful exposure includes at least one positive user interaction with a provided digital content.

The interactable component can be, for example, a uniform resource locator (URL) that, after being interacted with a user, directs the user to a particular profile associated with the URL. In some cases, the term “exposure” can also be referred to as “impression.” For simplicity, an exposure having a positive user interaction can also be referred to as a “user click” in the following description. Note the term “outcome” or “conversion” as used throughout this specification generally does not include a user click on an exposure that does not lead to a completion of an event (e.g., downloading a software application, closing a transaction, or other events). However, in some situations, the outcome can include the user click without considering following user activities.

The term “content channels” throughout this document generally refers to a service, a platform, and/or an interface through which a digital content can be provided to a viewer or audience. Example content channels include an application interface, a web page interface, a video streaming service, an audio streaming service, an emailing service, an on-line searching service, a navigation service, an online shopping platform, a social messaging platform, a social streaming platform, or other suitable services, platforms, and/or interfaces. In some implementations, different content channels can include services, platforms, and/or interfaces managed or owned by different parties. For example, content channels can include a first social messaging platform managed or owned by a first party, and a second social messaging platform managed or owned by a second party, which is different from the first party. In some situations, restrictions can prevent data from one content channel from being shared with devices or systems processing data from another content channel.

In some cases, a party can manage or run multiple content channels for providing digital contents to audiences. The party can further request one or more attribution models designed and/or trained to determine attributions of outcomes to exposures provided through the multiple content channels. Generally, the attribution models can analyze metadata associated with an outcome and one or more exposures from different channels to determine an exposure to which an outcome should be attributed. In these situations, restrictions or technical limitations can prevent data from one content channel from being shared with devices or systems processing data from another content channel.

In an environment where multiple content channels or platforms can provide digital contents to a client device (or an audience associated with the client device), it can be difficult to determine an exposure from a content channel to which an outcome is attributed. This is generally because a user/device identifier (e.g., an anonymized string of characters) might not be accessible or the user/device identifier might be lost, encrypted, or removed across different content channels. First, a user/device identifier might not be accessible when the user is exposed to a digital content through a content channel due to different reasons, e.g., one or more particular user privacy policies, and/or user's activities (e.g., a user does not login a user account, or does not have a registered account associated with the content channel). In addition, data representing the user/device identifiers are generally not shared or communicated across different content channels, in particular when different content channels are managed or owned by different parties. Therefore, the user/device identifiers acquired by a first content channel are not accessible by a second content channel.

As a naïve example, a user can be exposed to a digital content on a first platform run by a first party and at a later time, exposed to the same digital content on a second platform run by a second party. The first platform collects data representing the user/device identifiers, but does not communicate the identifier with the second platform. The second platform cannot access the user/device identifiers otherwise. The user completes an event (e.g., a conversion occurs) associated with the digital content on another platform managed by the second party. It can be considered that the outcome is attributed to the digital content on the second platform. However, from the point of view of the second party, an attribution model for content channels managed by the second party does not have metadata used for establishing a path that tracks the outcome to an exposure on the second platform.

Some outcomes have data indicating exposures that the outcomes are attributed to, which is also referred to as “observed outcome” or “observed attributions.” An observed attribution generally includes data indicating an outcome completed based on a positive user interaction with an exposure. For example, a user clicks or taps an URL embedded in a digital content and is brought to a profile where an outcome occurs. However, not every outcome has data indicating a clear path tracking an exposure, as described above. Outcomes without data indicating associated exposures are referred to as “unattributed outcomes,” as described above. In some implementations, one or more outcome models for a content channel are implemented to predict attributions for unattributed outcomes for the content channel. The predicted attributions generated by outcome models are generally referred to as “modeled attributions.”

This specification describes techniques for determining attributions for unattributed outcomes from different content channels. In particular, the described techniques include a central attribution engine configured to coordinate the operations among different models, and process unattributed outcomes based on different sets of modeled attribution, each set of the modeled attributions being predicted by a respective outcome model for a respective content channel. Each set of the modeled attributions can further include a respective measure indicating connections between unattributed outcomes and corresponding exposures through the corresponding content channel for which the outcome is dedicatedly designed to determine attributions. The central attribution engine is also referred to as a model orchestrator in this document.

The described techniques can analyze modeled predictions based on information associated with multiple different channels, and adjust or modify measures of sets of modeled predictions using the global information. In some implementations, the described techniques can determine one or more criteria based on the global information, and adjust measures in the modeled predictions based on the one or more criteria. The described techniques can determine updated attributions for these unattributed outcomes using the adjusted or modified measures. In some implementations, the system can also update modeled attributions based on the updated attributions to avoid conflicts in attributions, e.g., to prevent one outcome from being modeled to be attributed to multiple exposures. Since the central attribution engine or the model orchestrator obtains global information across different outcome models for different content channels, the attributions determined for the unattributed outcomes are more accurate than those determined by local outcome models.

For situations in which the systems discussed here collect and/or use personal information about users, the users may be provided with an opportunity to enable/disable or control programs or features that may collect and/or use personal information (e.g., information about a user's social network, social actions or activities, a user's preferences or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

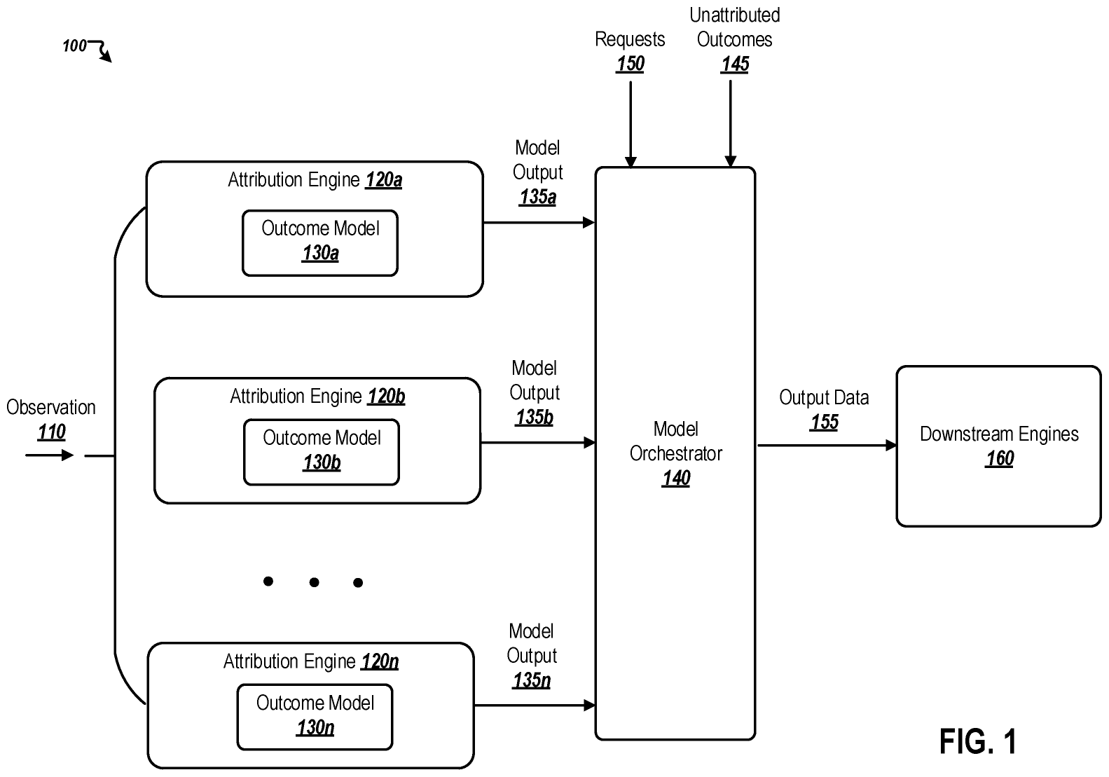

FIG. 1 is a block diagram of an example system 100 for determining attributions for unattributed outcomes. The example system 100 is an example of an attribution system that includes a model orchestrator 140 and implemented on one or more computers (e.g., nodes or machines) in one or more locations, in which systems, components, and techniques described below can be implemented. Some of the components of the system 100 can be implemented as computer programs configured to run on one or more computers.

As shown in FIG. 1, the system 100 can include one or more attribution engines 120a-120n. An attribution engine can include one or more processors in one or more locations configured to determine attributions for outcomes. In some implementations, each attribution engine 120a-120n can be assigned to a particular content channel for determining attributions for outcomes completed in the particular content channel. For example, a first attribution engine 120a is assigned to a first channel (e.g., a first social messaging platform), a second attribution engine 120b is assigned to a second channel (e.g., a first video streaming service), and an n^{th} attribution engine 120n is assigned to an online searching service. Other example content channels are described in greater detail as above.

Furthermore, each attribution engine 120a-n can include a respective outcome model 130a-n dedicatedly configured to determine outcomes for content channels assigned to corresponding attribution engines 120a-n. In other words, outcome models in attribution engines 120 do not have a global picture of exposures that an outcome can be attributed to across different content channels. Rather, an outcome model 130a-n generally covers predetermined exposures associated with corresponding content channels. For example, the attribution engine 120a includes an outcome model 130a, and the outcome model 130a can determine attributions for outcomes to a first set of predetermined exposures (e.g., exposures A, B, and, C) associated with corresponding content channels (e.g., channel 1 and channel 2). The attribution engine 120d includes an outcome model 130d, and the outcome model 130d can determine attributions for outcomes to a second set of predetermined exposures (e.g., exposures C, G, and K) associated with content channels (e.g., channel 2, channel 6, and channel 7).

In general, the attribution engine 120a-n receives as input the observation data 110 and generates respective model outputs 135a-n including observed and/or modeled attributions for outcomes based on the observation data 110. Observation data 110 can include metadata storing outcomes and “footprints” associated with outcomes. The term “footprint” generally refers to user historic activities or interactions with different exposures that might influence an outcome completed by the user. For example, the observation data 110 can include, for a first outcome, data that indicates a user click or tap on an URL when a user is viewing a digital content, and at a later time, the user completes a purchase on a webpage provided to the user by the URL. In this case, the observation data 100 can include an identifier for the user click or tap (e.g., a click ID), and associate the click ID with a corresponding identifier for the outcome event (e.g., an outcome ID). An outcome having observation data 110 indicating an exposure that the outcome should be attributed to is referred to as an “observed attribution,” as described above.

In some situations, the observation data 110 can include data indicating multiple exposures along user “footprints” for an outcome. For example, before an outcome is completed by an entity, the entity interacts with a first digital content through a first content channel (e.g., clicked on a digital content on a searching service webpage), and interacted with a second digital content through a second content channel (e.g., watched an entire video advertisement when watching a streamlining video on a video streaming platform). An attribution engine 120e assigned for the two content channels performs operations in the associated outcome model 130e to predict which exposure to which the outcome should be attributed. This type of outcome is also referred to as “modeled attribution,” as described above.

Sometimes the observation data 110 does not include a clear path tracing one or more exposures for an outcome due to different reasons. In some situations, due to particular privacy policies, data such as user/device identifiers for tracing user activities or interactions are removed from the observation data 110 provided to the system 100, or encrypted before the observation data 110 provided to the system 100 so that the system 100 cannot determine user activities or interactions for determining attributions. In some situations, data representing user/device identifiers are not communicated across different content channels, so that an outcome model 130a for a first channel does not know that a user completing an outcome has positively interacted with a digital content on a second channel, where the second channel does not share information with the first channel. In some implementations, data representing user/device identifiers might not be observed at all, a user completing an outcome might forget login to a user account when the user is exposed to a first digital content, and at a later time, completes an outcome on a retailing platform managed by attribution engine 120m. In the above-noted situations, outcomes without observation data linking one or more exposures to the outcome are referred to as “unattributed outcomes.” Outcome models do not generate accurate enough attributions, and sometimes generate misleading and/or conflicting attributions for unattributed outcomes.

For unattributed outcomes that do not have an established link or connection between the outcome and an exposure, the outcome models 130a-130n can predict an attribution for the outcome based on the predetermined exposures for content channels managed by corresponding outcome models. To predict an attribution, an example outcome model can generate a measure between unattributed outcomes and exposures in the predetermined set of exposures for the outcome model. The measure can include a likelihood of one or more unattributed outcomes being attributed to one or more exposures in the content channels for the outcome model. Note the predicted connections or mapping do not have to be one-to-one mapping. Instead, the mappings or connections can be many-to-one mapping or one-to-many mapping. For example, a outcome model for content channels A, B, C can determine a first unattributed outcome without data representing the user/device identifiers being attributed to an exposure from content channel A of a likelihood of 50%, a second unattributed outcome being attributed to an exposure from content channel B of a likelihood of 10%, and a third unattributed outcome being attributed to an exposure from content channel C of a likelihood of 20%. As another example, an outcome model can determine a first unattributed outcome without data representing the user/device identifiers being attributed to an exposure from content channel A of a likelihood of 40%, to an exposure from content channel B of a likelihood of 5%, and to an exposure from content channel C of a likelihood of 15%. As another example, a outcome model can determine a first unattributed outcome without data representing the user/device identifiers being attributed to an exposure from content channel A of a likelihood of 70%, a second unattributed outcome being attributed to an exposure from content channel A of a likelihood of 21%, and a third unattributed outcome being attributed to an exposure from content channel A of a likelihood of 3%. Once the outcome model determines an attribution for an unattributed outcome, the unattributed outcome is now also referred to as a “modeled attribution,” for simplicity. The attribution engines 120a-n output modeled attributions in corresponding model outputs 135a-n.

System 100 includes a model orchestrator 140 configured to resolve the above-noted difficulties. More specifically, the model orchestrator 140 can efficiently determine accurate attributions for unattributed outcomes based on global information collected from multiple attribution engines 120a-120n.

As shown in FIG. 1, upon receiving one or more requests 150 for determining attributions for unattributed outcomes 150, the model orchestrator 140 can process input unattributed outcomes 145 to generate output data 155 having attributions determined for the unattributed outcomes 145. In some implementations, the requests 150 can be received from an entity who uses one or more services provided by the system 100 (e.g., a service for determining attributions for outcomes completed in corresponding content channels). The entity can send requests 150, for example, using a client device. Note that the model orchestrator 140 is not required to receive a request to process unattributed outcomes. Rather, the model orchestrator 140 can perform the processing on a scheduled basis, or otherwise automatically process the unattributed outcomes without first receiving a request.

In some implementations, unattributed outcomes can be processed automatically by system 100 based on one or more predetermined criteria. For example, one example criterion can be a threshold number of unattributed outcomes. If the system 100 determines a total number of unattributed outcomes is equal to or greater than the threshold number, the system 100 can automatically generate requests 150 to the model orchestrator 140 for determining attributions for the unattributed outcomes 145.

In some implementations, the requests 150 can be included in the model output 135a-n generated from corresponding attribution engines 120a-n. Outcome models 130a-n sometimes cannot determine a proper exposure that an outcome should be attributed to due to the lack of user-related information from the observation data 110. Therefore, the outcome models 130a-n can output unattributed outcomes included in the model output 135a-n. The attribution engines 120a-n can determine whether it is needed to generate requests for model orchestrator 140 to further process the unattributed outcome in the model outputs 135a-n. For example, the attribution engines 120a-n can determine a ratio of number of unattributed outcome versus all outcomes in the model outputs 135a-n, and compare the ratio against a threshold ratio. If the ratio satisfies the threshold ratio, the attribution engines 120a-n can generate requests to be included in the model outputs 135a-n for model orchestrator 140 to process the unattributed outcomes.

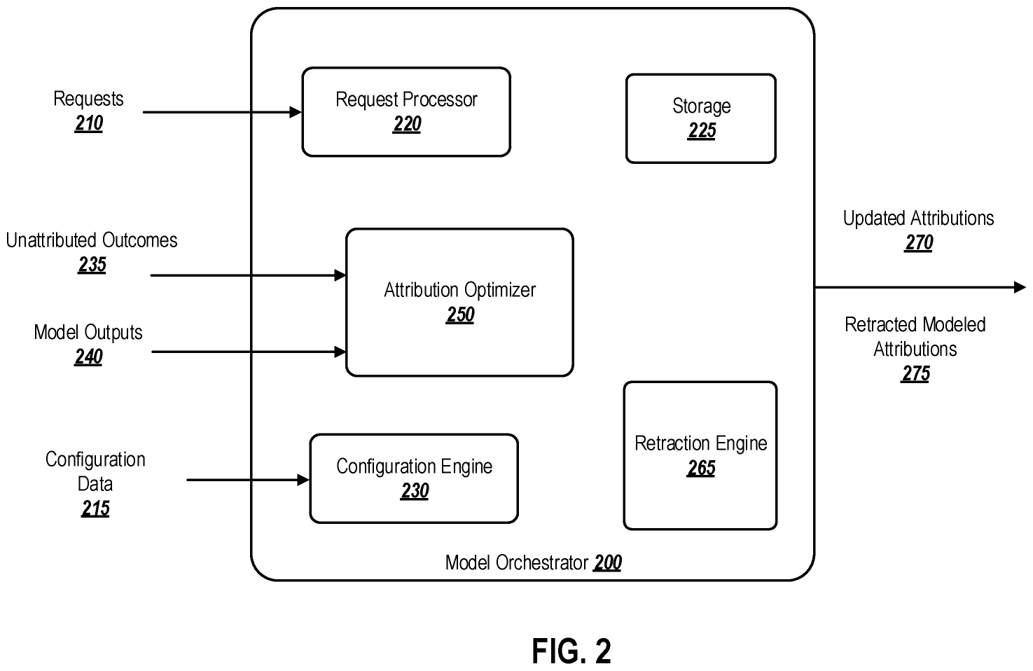

In general, the model orchestrator 140 processes a set of unattributed outcomes 145 and modeled attributions generated from outcome models to determine attributions for the unattributed outcomes 145. In some implementations, the model orchestrator 140) also receives unattributed outcomes from model outputs 134a-n from different attribution engines 120a-n, as described above. The techniques are efficient because the model orchestrator 140 does not need to repeat the operations for modeling attributions that were performed by attribution engines 120a-n. Rather, the model orchestrator 140) is configured to adjust or update the modeled attributions based on the global information for all observation data 110 and outcome models 130a-n. The model orchestrator 140, for example, can adjust or modify predicted measures for modeled attributions based on one or more criteria. The one or more criteria are determined or selected according to different attribution requirements, or specified by user input or in the requests 150. The details of determining updated attributions for unattributed outcomes based on modeled attributions are described in greater detail in connection with FIG. 2.

After determining the updated attributions for unattributed outcomes 145, the model orchestrator 140 can further retract some of the modeled attributions if they are different from the updated attributions. For example, if a modeled attribution for a first unattributed outcome indicates an exposure A that the outcome should be attributed to, but a corresponding updated attribution for the first unattributed outcome indicates a different exposure, say, exposure B, the system 100 or the model orchestrator 140 can retract the modeled attribution. The term “retract” generally refers to nullifying the modeled attribution, breaking up a link or connection between a outcome and an exposure predicted by the modeled attribution, or deleting or not storing the modeled outcome in storage.

The model orchestrator 140 generates output data 155 including the updated attributions and provides the output data 155 for further operations performed by one or more downstream engines 160. The operations can include any suitable operations according to different attribution requirements. For example, one operation could be to generate a report based on the updated attributions to cast light on questions of interest, e.g., how efficient or influential a particular exposure can be to achieve an outcome, which content channel generates the most outcomes, or other questions of interest. Another example operation could be to adjust different exposures presented to viewers based on the updated attributions. In some implementations, the downstream engines 160 include again the model orchestrator 140, which is configured to process remaining unattributed outcomes included in the output data 155.

In some implementations, the output data 155 can further include one or more unattributed outcomes 145 that the model orchestrator 140 does not determine during a current time cycle. The downstream operations can include providing the one or more unattributed outcomes 145 to one or more of the attribution engines 120a-n or the model orchestrator 140 for further processing during a next time cycle.

FIG. 2 is a block diagram of an example model orchestrator 200 included in the example system. The example model orchestrator 200 can be equivalent to the model orchestrator 140 in FIG. 1, and the example system can be equivalent to the example system 100 in FIG. 1. Here, components of the model orchestrator 200 and operations performed by the model orchestrator 200 are described in greater detail.

As shown in FIG. 2, the model orchestrator 200 includes a request processor 220) configured to receive and process requests 210. As described above, the requests 210 can be received from entities of the service, or from model outputs 240 from different attribution engines (e.g., attribution engine 120a-n in FIG. 1). In some implementations, the operations performed by the model orchestrator 200 are not required to be triggered by any requests, as described above. The request processor 220 can include data structures for storing different queues received. For example, the request processor 220 can include a queue structure (e.g., a first in first out (FIFO) queue).

The model orchestrator 200 further includes a configuration engine 230 for receiving configuration data 215. The configuration data 215 can include data specifying one or more attribution engines to be registered for the model orchestrator 200, so that the model orchestrator will obtain model output from the registered attribution engines for processing unattributed outcomes. The configuration data 215 can further include a schedule for the model orchestrator, which generally specifies a mechanism for determining updated measures of modeled attributions and sampling exposures from the updated measures. In some implementations, the configuration data 215 can further include capping configurations which determine a size of a set of modeled attributions, and/or a global threshold ratio of observed attributions versus modeled attributions from all registered attribution engines (in other words, a global capping).

The received requests 210 and configuration data 215 can be stored in storage 225 in the model orchestrator 200. In some implementations, storage 225 can be a distributed database with each node having multiple replicas of the storage. In this way, the system can avoid undesired data loss or damage due to hardware malfunction.

The model orchestrator 200 further includes an attribution optimizer 250 for processing unattributed outcomes 235 based on model outputs 240. The model outputs 240) are obtained from attribution engines registered for the model orchestrator 200. The model outputs 240 include multiple modeled attributions generated by respective outcome models for respective content channels. In some implementations, the model outputs 240) can also include unattributed outcomes that are not processed by attribution engines.

In some implementations, the model outputs 240 can include requests for sampling exposures for modeled attributions. The requests can include a scored path, one or more capping configurations, and/or one or more retraction requests. A scored path generally refers to data that represent user interactions or activities with one or more exposures, and data indicating a number of outcomes to sample for respective exposures. In some cases, the scored path can further include data associated with a outcome, for example, data indicating whether a outcome is a modeled attribution or an observed attribution, whether a outcome has data tracking back to one or more exposures, when a outcome was completed, and/or a geographical location associated with a outcome. The capping configurations, similar to the global capping configurations described above, include data representing a threshold ratio between modeled attributions versus observed attribution for each outcome model (i.e., local cappings). The capping configurations further include data associated with exposures and content channels, for example, data representing IDs for exposures or campaigns, and/or data representing a device where a digital content is provided to a viewer.

In some implementations, the model outputs 240 can further include requests to retract modeled attributions that are incorrect, e.g., modeled attributions that are different from the updated attributions generated by the model orchestrator 200. The details of retracting a modeled attribution is described below.

The attribution optimizer 250 is configured to obtain respective measures in different sets of modeled attributions, each set of modeled attributions being generated by a respective outcome model from a registered attribution engine. As described above, each measure for a set of modeled attributions can include a probability distribution that includes multiple likelihoods for outcomes being attributed to exposures through content channels for the outcome model. The probability distribution can be used by the model orchestrator 200 to sample an exposure from the set of predetermined exposures for an outcome.

To generate updated measures (e.g., updated probability distributions) for sampling an exposure for an attribution outcome, the attribution optimizer analyzes the respective measures from different sets of modeled attributions, and determines whether to adjust or modify one or more measures based on one or more criteria. Examples of the one or more criteria are described in greater detail below.

For an unattributed outcome of the set of unattributed outcomes 235, the model orchestrator 200 can determine sets of modeled attributions from respective outcome models that have performed attribution operations for the unattributed outcomes. The model orchestrator 200 analyzes information associated with the sets of modeled attributions to determine whether it is needed to adjust or modify respective measures for one or more of the selected sets of modeled attributions. In response to determining that it is needed to adjust or modify the respective measures, the model orchestrator 200 modifies values of the respective measures based on one or more criteria.

For example, for an outcome of purchasing a watch on a retailing platform, a first outcome model determines that the outcome is attributed to a first channel (e.g., exposures on a searching engine webpage) with a likelihood of 70%, and to a second channel (e.g., exposures on a video streaming platform) with a likelihood of 20%. A second outcome model determines that the same outcome is attributed to a third channel (e.g., exposures on a social messaging platform) with a likelihood of 55%. The model orchestrator 200 obtains the two sets of modeled attributions from the two outcome models, and determines which exposure and which channel that the outcome of purchasing a watch should be attributed to. For example, if the model orchestrator 200 obtains data indicating that the user didn't use the searching engine to search information related to the watch or the search for such information was performed a time period ago greater than a threshold time period, the model orchestrator 200 can adjust the likelihood of 70% to, for example, 30%, 20%, 5%, or other suitable likelihood values. In some implementations, the model orchestrator can uniform or rescale the probability distributions from different outcome models. For instance, taking the above-noted example, the model orchestrator 200 can rescale the likelihood for a search engine to be 20%, the likelihood for a video streaming platform to be 10%, and the likelihood for a social messaging platform to be 60%.

The model orchestrator 200 generates updated attributions based on the updated measures. Each updated attribution indicates a respective unattributed outcome of the set of unattributed outcomes being attributed to a corresponding exposure of the set of predetermined exposures. For example, the model orchestrator 200 can select an exposure with the maximum likelihood in the updated probability distributions as the exposure to which an unattributed outcome is attributed. Alternatively, the model orchestrator 200 can determine a group of candidate exposures for an outcome according to a threshold probability value, and then, select one exposure from the group of candidate exposures as an attribution for the outcome based on the respective probably values of the group of candidate exposures. As another example, the orchestrator 200 can determine exposures for unattributed outcomes so that it can minimize the remaining unattributed outcomes. In other words, the orchestrator 200 determines as many exposures for unattributed outcomes as possible based on the updated measures.

The model orchestrator 200 can repeatedly perform the above-noted operations for different unattributed outcomes, until reaching a stopping point. The stopping point can be determined by comparing a number of iterations or a real-time runtime against a threshold value. Once the number of iterations or the real-time runtime is equal to or greater than the threshold value, the model orchestrator 200 stops generating updated attributions for unattributed outcomes 235.

The one or more criteria used for updating respective measures can be determined by a user input or preset for the system, according to different attribution requirements. For example, one or more criteria can be specified in the configuration data 215. Alternatively, the one or more criteria can be stored in storage 225.

In some implementations, the one or more criteria can include an outcome volume threshold for an outcome model. The outcome volume can be generally presented by a ratio of unattributed outcomes assigned to an outcome model versus the entire set of unattributed outcomes. For example, if an outcome model is assigned with too many unattributed outcomes for determining attributions, e.g., an outcome volume greater than a predetermined threshold value, the model orchestrator 200 would update values for respective measures in modeled outcomes for the outcome model.

In some implementations, the one or more criteria can include an attribute associated with an unattributed outcome. The attribute associated with an unattributed outcome can include a geographical location where the unattributed outcome is completed. Alternatively or in addition, the attribute can include a time value when the unattributed outcome is completed. The model orchestrator 200 can obtain from the model outputs 240 data indicating when and where an outcome is completed, and compare the time value against a time value an exposure is presented to a user, and/or compare the geographical location with a geographical location associated with an exposure. The model orchestrator 200 determines whether an update in measure values is needed based on the comparison results. For example, an outcome associated with a geographical location in California, the United States might be unlikely to be attributed to an exposure associated with a location in Germany. Given that, the model orchestrator 200 determines to update a measure value for a corresponding modeled attribution. As another example, an outcome completed at a time earlier than a time when an exposure is presented to a user might be unlikely to be attributed to the exposure. Given that, the model orchestrator 200 determines to update a measure value for a corresponding modeled attribution.

In some implementations, the one or more criteria can include a threshold similarity value between an unattributed outcome and an exposure predicted by a modeled attribution. The model orchestrator 200 can determine whether to update a measure value based on a comparison between the threshold similarity value and a calculated similarity value. For example, the system 100 of FIG. 1 or the model orchestrator 200 can calculate a similarity value for an unattributed outcome and a predicted exposure from a modeled attribution, by determining a distance between features of the outcome and the exposure in an embedding space. The model orchestrator 200 can compare the similarity value with the threshold similarity value to determine whether updating a measure value in a modeled attribution is needed. Example similarity values can be a percentage ranging from zero to one, where zero represents the least similar, and one represents the most similar or substantially the same, in this case, the threshold similarity value can be 0.75, 0.9, 0.95, or other suitable similarity values.

In some implementations, the one or more criteria can include a threshold number or ratio of remaining unattributed outcomes in the set of attributed outcomes. The threshold value can be determined according to different attribution requests. For example, the threshold ratio can be 10%, 30%, 50%, or other suitable ratios. If the remaining unattributed outcomes are greater than or equal to the threshold value, the model orchestrator 200 can determine not to update measures in modeled attributions. In this way, the model orchestrator 200 can avoid unnecessary updates when the modeled attributions do not conflict, and can lean to updating modeled attributions when unattributed outcomes are below a threshold to prevent potential conflicts in modeled attributions.

Alternatively or in addition, one or more of the above-noted criteria can be dependent on the threshold number of remaining unattributed outcomes in the set of attribution outcomes. For example, when the number of remaining unattributed outcomes satisfies the threshold number of remaining unattributed outcomes, the model orchestrator 200 does not update parameters of the modeled attributions. As another example, when the number of remaining unattributed outcomes satisfies the threshold number of remaining unattributed outcomes, at least one of the above-noted criteria can be relaxed by the model orchestrator 200 to different extents according to different requirements. For example, the threshold similarity value can be doubled than the original threshold similarity value.

The model orchestrator 200 can further include a retraction engine 265 to retract modeled attributions that do not harmonize with the updated attributions. For example, for a first outcome, the updated attributions might indicate it is attributed to a first exposure. However, a previous modeled attribution from an outcome model indicates the first outcome is attributed to a second exposure, different from the first exposure. The model orchestrator 200 can delete the modeled attribution or remove a connection between the outcome and the second exposure, as described above.

After processing the unattributed outcomes 235, the model orchestrator 200 is configured to provide output data for downstream operations. The output data can include updated attributions 270 and retraced modeled attributions 275. The updated attributions 270 can be used for generating a campaign report for entities of the attribution service. The retraced modeled attributions 275 can be used to correct previously generated reports, and/or are fed back to the model orchestrator 200 for processing in a next time cycle.

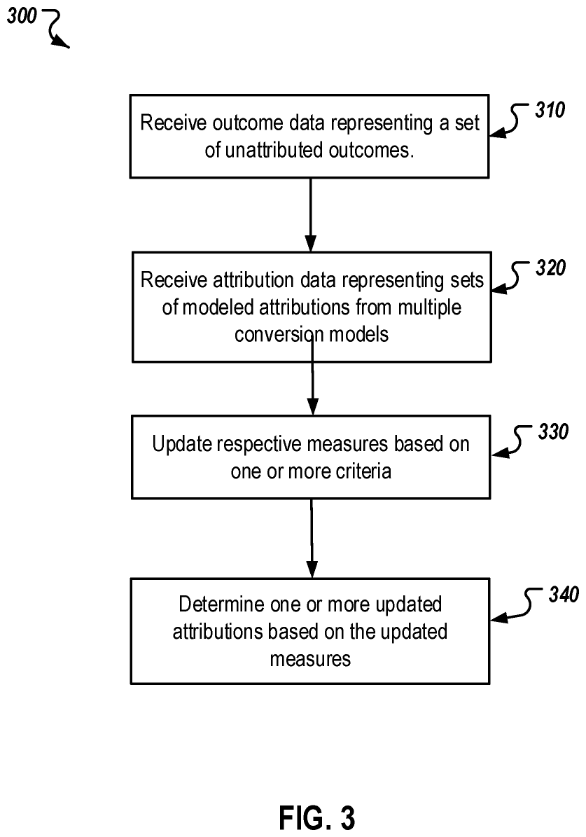

FIG. 3 is a flow diagram of an example process for determining attributions for unattributed outcomes. For convenience, the above-noted process 300 is described as being performed by a system of one or more computers located in one or more locations. For example, a system, e.g., the example of attribution system 100 of FIG. 1, appropriately programmed, can perform the process 300.

First of all, the system receives a request for determining attributions of a set of unattributed outcomes to a set of predetermined exposures. The request can be received from an entity using a service provided by the system. In some implementations, the request can be included in model outputs generated by multiple outcome models. In some implementations, the system is not required to receive a request for performing operations to determine attributions for unattributed outcomes.

The system generally determines an output in response to the request. The output is determined based on one or more updates to modeled attributions for one or more unattributed outcomes. The details of generating the output are described below. Note the set of predetermined exposures include exposures of different channels managed by different outcome models. In other words, the system determines attribution over a global picture of all exposures in corresponding content channels.

The system receives outcome data representing a set of unattributed outcomes (310). As described above, an unattributed outcome of the set of unattributed outcomes does not have an observed attribution to an exposure of a set of predetermined exposures. Alternatively or in addition, the unattributed outcomes do not have data indicating clear paths tracking corresponding exposures due to different reasons, e.g., particular privacy policies.

The system receives attribution data representing a set of modeled attributions from each outcome model of multiple outcome models (320). A modeled attribution of the sets of modeled attributions indicates an attribution of an unattributed outcome to an exposure of the set of predetermined exposures. Each set of the sets of modeled attributions includes a respective measure between one or more of the set of unattributed outcomes and one or more of the set of predetermined exposures. A measure for a set of modeled attributions can include a probability distribution indicating one or more likelihoods of one or more unattributed outcomes being attributed to one or more corresponding exposures of the set of exposures.

The system updates the respective measures in the sets of modeled attributions received from the plurality of outcome models based on one or more criteria (330). The one or more criteria can include an outcome volume threshold for an outcome model, an attribute associated with an unattributed outcome such as a geographical location, a threshold similarity between an unattributed outcome and a corresponding modeled attribution, a threshold number of remaining unattributed outcomes in the set of unattributed outcomes, or other suitable criteria. The details of the example criteria are described above.

The system determines, based on the updated respective measures, one or more updated attributions (340). Each updated attribution indicates a new attribution of a respective outcome from the set of unattributed outcomes to a corresponding exposure of the set of predetermined exposures.

Optionally, when determining updated attributions, the system can retract modeled attributions that are inconsistent with updated attributions. To retract, the system deletes or nullifies previously predicted modeled attributions, and updates one or more modeled attributions of the sets of modeled attributions based on the one or more updated attributions.

In some implementations, the system can provide the one or more updated attributions for one or more downstream operations. Example downstream operations can include generating one or more reports based on the updated attributions for entities subscribing to the attribution service. Optionally, the output generated by the system can still include one or more unattributed outcomes, and these unattributed outcomes can be provided back to the system for processing in a next time cycle.

In some implementations, the system can generate one or more attribution reports based on the one or more updated attributions. The report can include information related to newly determined attributions for previously unattributed outcomes, newly updated or changed attributions for outcome attributions that are modeled by the upstream conversion models, and/or the remaining unattributed outcomes output from the model orchestrator. The report can be of any suitable forms, for example, digital data having digital figures, charts, tables, images, audios, videos, or other suitable formats that are to be transmitted to another module, to be printed out on paper, or to be displayed on a display.

In some implementations, the system can determine digital content to be provided to a client device based on the one or more updated attributions. The system can further provide data including the digital content to a display of the client device for display. Alternatively, the system can determine and provide digital content to a client device based on an attributed report, as described above.

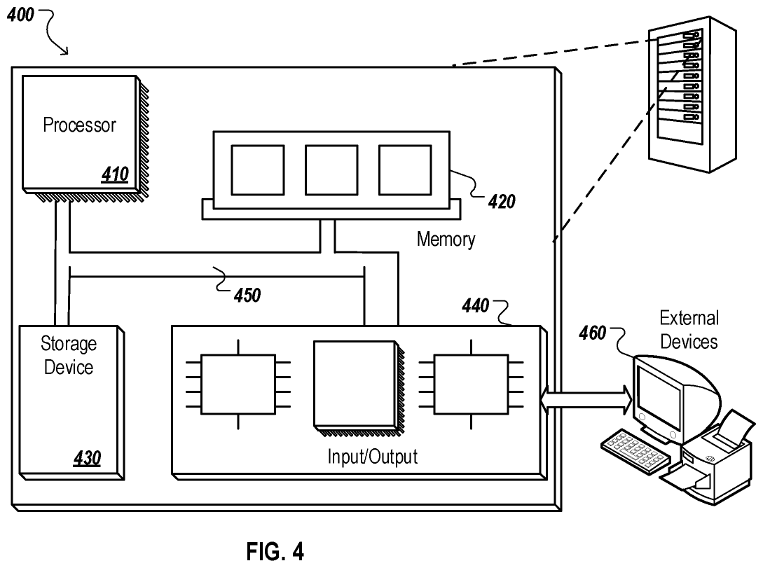

FIG. 4 is a block diagram of an example computer system 400. The example computer system 400 can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In another implementation, the processor 410 is a multi-threaded processor. The processor 410 is capable of processing instructions stored in memory 420 or on the storage device 430.

The memory 420 stores information within the system 400. In one implementation, the memory 420 is a computer-readable medium. In some implementations, the memory 420 is a volatile memory unit. In another implementation, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In some implementations, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to external devices 860, e.g., keyboard, printer and display devices. Other implementations, however, can also be used, such as mobile computing devices, mobile communication devices, set-top box television client devices, etc.

Although an example processing system has been described in FIG. 1, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto-optical disks: and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well: for example, feedback provided to the user can be any form of sensory feedback, e.g., visual feedback, auditory feedback, or tactile feedback: and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In addition to the embodiments described above, the following examples are also innovative:

Example 1 is a method comprising: receiving, by a model orchestrator including one or more processors, outcome data representing a set of unattributed outcomes, wherein an unattributed outcome of the set of unattributed outcomes does not have an observed attribution to an exposure of a set of predetermined exposures; receiving, by the model orchestrator, attribution data representing a set of modeled attributions from each outcome model of a plurality of outcome models, wherein each set of the sets of modeled attributions comprises a respective measure between one or more of the set of unattributed outcomes and one or more of the set of predetermined exposures: updating the respective measures in the sets of modeled attributions received from the plurality of outcome models based on one or more criteria: and determining, based on the updated respective measures, one or more updated attributions, wherein each updated attribution indicates a new attribution of a respective outcome from the set of unattributed outcomes to a corresponding exposure of the set of predetermined exposures.

Example 2 is the method of Example 1, wherein a modeled attribution of the sets of modeled attributions indicates an attribution of an unattributed outcome to an exposure of the set of predetermined exposures.

Example 3 is the method of Example 1 or 2, further comprising: updating one or more modeled attributions of the sets of modeled attributions based on the one or more updated attributions, wherein the updating comprises retracting a modeled attribution so that a corresponding outcome is no longer attributed to an exposure indicated by the modeled attribution.

Example 4 is the method of any one of Examples 1-3, further comprising: providing the one or more updated attributions for one or more downstream operations that generate a report based at least on the one or more updated attributions.

Example 5 is the method of any one of Examples 1-4, further comprising: generating an attribution report based on the one or more updated attributions.

Example 6 is the method of any one of Examples 1-5, further comprising: determining a digital content to be provided to a client device based on the one or more updated attributions, and transmitting data including the digital content to the client device.

Example 7 is the method of any one of Examples 1-6, wherein the respective measure between one or more of the set of unattributed outcomes and one or more of the set of predetermined exposures comprises a probability distribution indicating a likelihood of an unattributed outcome being attributed to one or more corresponding exposures.

Example 8 is the method of any one of Examples 1-7, wherein the respective measure between one or more of the set of unattributed outcomes and one or more of the set of predetermined exposures comprises a probability distribution indicating a likelihood of one or more unattributed outcomes being attributed to a corresponding exposure.

Example 9 is the method of any one of Examples 1-8, wherein updating the respective measures in the sets of modeled attributions based on the one or more criteria comprises: for an unattributed outcome of the set of unattributed outcomes, selecting sets of modeled attributions from one or more of the plurality of outcome models, wherein each of the selected sets of modeled attributions comprises the respective measure for the unattributed outcome: obtaining, from each of the one or more of the plurality of outcome models, a respective value of the measure for the unattributed outcome; modifying the respective values of the measure for the unattributed outcome based on the one or more criteria.

Example 10 is the method of any one of Examples 1-9, wherein the one or more criteria comprise at least one or more of: an outcome volume threshold for an outcome model, an attribute associated with an unattributed outcome, a threshold similarity value between an unattributed outcome and a corresponding exposure predicted by a modeled attribution, or a threshold number of remaining unattributed outcomes in the set of unattributed outcomes.

Example 11 is the method of Example 10, wherein the attribute is a geographical location associated with the unattributed outcome.

Example 12 is the method of any one of Examples 1-11, further comprising: receiving a request from an entity for determining attributions of the set of unattributed outcomes to the set of predetermined exposures, and responsive to receiving the request, generating an output based on the one or more updated attributions corresponding to the request.

Example 13 is a system comprising one or more computers and one or more storage devices storing instructions that are operable, when executed by the one or more computers, to cause the one or more computers to perform the method of any one of embodiments 1 to 12.

Example 14 is a computer storage medium encoded with a computer program, the program comprising instructions that are operable, when executed by a data processing apparatus, to cause the data processing apparatus to perform the method of any one of embodiments 1 to 12.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving, by a model orchestrator including one or more processors, outcome data representing a set of unattributed outcomes, wherein an unattributed outcome of the set of unattributed outcomes does not have an observed attribution to an exposure of a set of predetermined exposures;
receiving, by the model orchestrator, attribution data representing a set of modeled attributions from each outcome model of a plurality of outcome models, wherein each set of the sets of modeled attributions comprises a respective measure between one or more of the set of unattributed outcomes and one or more of the set of predetermined exposures;
updating the respective measures in the sets of modeled attributions received from the plurality of outcome models based on one or more criteria; and
determining, based on the updated respective measures, one or more updated attributions, wherein each updated attribution indicates a new attribution of a respective outcome from the set of unattributed outcomes to a corresponding exposure of the set of predetermined exposures.

2. The method of claim 1, wherein a modeled attribution of the sets of modeled attributions indicates an attribution of an unattributed outcome to an exposure of the set of predetermined exposures.

3. The method of claim 1, further comprising:
updating one or more modeled attributions of the sets of modeled attributions based on the one or more updated attributions, wherein the updating comprises retracting a modeled attribution so that a corresponding outcome is no longer attributed to an exposure indicated by the modeled attribution.

4. The method of claim 1, further comprising:
providing the one or more updated attributions for one or more downstream operations that generate a report based at least on the one or more updated attributions.

5. The method of claim 1, further comprising:
generating an attribution report based on the one or more updated attributions.

6. The method of claim 1, further comprising:
determining digital content to be provided to a client device based on the one or more updated attributions, and
transmitting data including the digital content to the client device.

7. The method of claim 1, wherein the respective measure between one or more of the set of unattributed outcomes and one or more of the set of predetermined exposures comprises a probability distribution indicating a likelihood of an unattributed outcome being attributed to one or more corresponding exposures.

8. The method of claim 1, wherein the respective measure between one or more of the set of unattributed outcomes and one or more of the set of predetermined exposures comprises a probability distribution indicating a likelihood of one or more unattributed outcomes being attributed to a corresponding exposure.

9. The method of claim 1, wherein updating the respective measures in the sets of modeled attributions based on the one or more criteria comprises:
for an unattributed outcome of the set of unattributed outcomes, selecting sets of modeled attributions from one or more of the plurality of outcome models, wherein each of the selected sets of modeled attributions comprises the respective measure for the unattributed outcome;
obtaining, from each of the one or more of the plurality of outcome models, a respective value of the measure for the unattributed outcome;
modifying the respective values of the measure for the unattributed outcome based on the one or more criteria.

10. The method of claim 1, wherein the one or more criteria comprise at least one or more of: an outcome volume threshold for an outcome model, an attribute associated with an unattributed outcome, a threshold similarity value between an unattributed outcome and a corresponding exposure predicted by a modeled attribution, or a threshold number of remaining unattributed outcomes in the set of unattributed outcomes.

11. The method of claim 10, wherein the attribute is a geographical location associated with the unattributed outcome.

12. The method of claim 1, further comprising:
receiving a request from an entity for determining attributions of the set of unattributed outcomes to the set of predetermined exposures, and
responsive to receiving the request, generating an output based on the one or more updated attributions corresponding to the request.

13. A system comprising one or more computers and one or more storage devices storing instructions that are operable, when executed by the one or more computers, to cause the one or more computers to perform operations, the operations comprising:
receiving, by a model orchestrator including one or more processors, outcome data representing a set of unattributed outcomes, wherein an unattributed outcome of the set of unattributed outcomes does not have an observed attribution to an exposure of a set of predetermined exposures;
receiving, by the model orchestrator, attribution data representing a set of molded attributions from each outcome model of a plurality of outcome models, wherein each set of the sets of modeled attributions comprises a respective measure between one or more of the set of unattributed outcomes and one or more of the set of predetermined exposures;
updating the respective measures in the sets of modeled attributions received from the plurality of outcome models based on one or more criteria; and
determining, based on the updated respective measures, one or more updated attributions, wherein each updated attribution indicates a new attribution of a respective outcome from the set of unattributed outcomes to a corresponding exposure of the set of predetermined exposures.

14. (canceled)

15. The system of claim 13, wherein a modeled attribution of the sets of modeled attributions indicates an attribution of an unattributed outcome to an exposure of the set of predetermined exposures.

16. The system of claim 13, wherein the operations further comprise:
updating one or more modeled attributions of the sets of modeled attributions based on the one or more updated attributions, wherein the updating comprises retracting a modeled attribution so that a corresponding outcome is no longer attributed to an exposure indicated by the modeled attribution.

17. The system of claim 13, wherein the one or more criteria comprise at least one or more of: an outcome volume threshold for an outcome model, an attribute associated with an unattributed outcome, a threshold similarity value between an unattributed outcome and a corresponding exposure predicted by a modeled attribution, or a threshold number of remaining unattributed outcomes in the set of unattributed outcomes.

18. A computer storage medium encoded with a computer program, the program comprising instructions that are operable, when executed by a data processing apparatus, to cause the data processing apparatus to perform operations, the operations comprising:
receiving, by a model orchestrator including one or more processors, outcome data representing a set of unattributed outcomes, wherein an unattributed outcome of the set of unattributed outcomes does not have an observed attribution to an exposure of a set of predetermined exposures;
receiving, by the model orchestrator, attribution data representing a set of modeled attributions from each outcome model of a plurality of outcome models, wherein each set of the sets of modeled attributions comprises a respective measure between one or more of the set of unattributed outcomes and one or more of the set of predetermined exposures;
updating the respective measures in the sets of modeled attributions received from the plurality of outcome models based on one or more criteria; and
determining, based on the updated respective measures, one or more updated attributions, wherein each updated attribution indicates a new attribution of a respective outcome from the set of unattributed outcomes to a corresponding exposure of the set of predetermined exposures.

19. The computer storage medium of claim 18, wherein a modeled attribution of the sets of modeled attributions indicates an attribution of an unattributed outcome to an exposure of the set of predetermined exposures.

20. The computer storage medium of claim 18, wherein the operations further comprise:
updating one or more modeled attributions of the sets of modeled attributions based on the one or more updated attributions, wherein the updating comprises retracting a modeled attribution so that a corresponding outcome is no longer attributed to an exposure indicated by the modeled attribution.

21. The computer storage medium of claim 18, wherein the one or more criteria comprise at least one or more of: an outcome volume threshold for an outcome model, an attribute associated with an unattributed outcome, a threshold similarity value between an unattributed outcome and a corresponding exposure predicted by a modeled attribution, or a threshold number of remaining unattributed outcomes in the set of unattributed outcomes.
